(19) United States
(12) Patent Application Publication
(10) Pub. No.: US 2019/0128349 A1
(43) Pub. Date: May 2, 2019

(54) Hydraulic Disc Brake Assembly and Pad Assembly for Same

(71) Applicant: TRW Limited, Solihull West Midlands (GB)

(72) Inventor: Mark Clent, Willenhall West Midlands (GB)

(73) Assignee: TRW Limited, Solihull West Midlands (GB)

(21) Appl. No.: 16/098,544

(22) PCT Filed: May 3, 2017
(86) PCT No.: PCT/GB2017/051238

§ 371 Date: Nov. 2, 2018

(30) Foreign Application Priority Data
May 5, 2016 (GB) 1607866.9

(51) Int. Cl. F16D 65/097; F16D 65/00; F16D 55/226

(52) U.S. Cl. CPC F16D 65/0971; F16D 2121/02; F16D 55/226; F16D 65/0006

(57) ABSTRACT

A hydraulic brake caliper assembly comprising a support bracket, a caliper, and a pair of spaced apart brake pad assemblies, each comprising a backing plate and a brake pad of friction material secured to the backing plate. The support bracket includes a pair of abutment sections associated with each brake pad assembly that are located so that during frictional engagement of the brake pad with a rotating brake disc one of the abutment sections abuts the backing plate of the brake pad to transfer reaction forces applied to the brake pads by the brake disc into the caliper. One of the brake pad assemblies further comprises an inner shim secured to the back face of the backing plate that faces away from the brake pad, and an outer shim that overlays the inner shim and is secured to the backing plate by a plurality of retaining clips. The retaining clips resiliently deflect in use to permit tangential movement of the backing plate relative to the outer shim whilst the backing plate is engaged with at least one of the resilient clips so as to provide a degree of self centering of the outer shim relative to the backing plate within an allowable range of movement.

### CROSS-REFERENCE TO RELATED APPLICATIONS

This application is a national stage of International Application No. PCT/GB2017/051238, filed 3 May 2017, the disclosures of which are incorporated herein by reference in entirety, and which claimed priority to Great Britain Patent Application No. 1607866.9, filed 5 May 2016, the disclosures of which are incorporated herein by reference in entirety.

### BACKGROUND TO THE INVENTION

The invention is related to the technical area of hydraulic disc brakes used in automotive vehicle braking systems.

Hydraulic disc brakes comprise a pair of brake pads arranged at opposite sides of a rotating brake disc which can be pressed onto the disc by a force generated by a hydraulically and/or electromechanically driven piston in order to decelerate the vehicle. The piston is typically driven by pressurized hydraulic fluid or by an electric motor acting through a gear set, or other source of pressure.

The invention in particular relates to sliding caliper disc brakes 1 of the kind as illustrated in FIG. 1 and FIG. 2 of the accompanying drawings. A sliding caliper disc brake typically comprise a support bracket 2 rigidly mounted to an axle or other fixed part of the vehicle on which a caliper 3 is slidingly mounted supported by an axially moveable guide system. The guide system may typically comprise two guide pins 5 fixed to the caliper 3 which each extend, when the caliper is mounted to the bracket 2, into a respective axially extending guide bore arranged in the bracket 2. The bracket 2 holds a pair of brake pad assemblies 100. The bracket includes radial abutment sections 21, 22 for them used to transfer the tangentially directed reaction forces from the pads into the bracket 2 during frictional engagement with a rotating brake disc 5.

At least one piston 4 is provided in a bore in the caliper and acts on a back face of one of the pad assemblies to urge the front face of the pad assembly into engagement with the disc. The pad on the other side of the disc is then compressed between the disc and a reaction surface 6 on the opposing side of the caliper that reacts the forces applied by the piston 4.

The brake pad assembly 100 consists of a friction lining 110 on the front face attached to a metal back plate 120. The function of the back plate is to support the friction pad and to transfer the reaction forces into the surrounding bracket by abutment means 21, 22. To reduce unwanted noise output especially a so called “squeal” noise the back face of the back plate of the pad assembly may be provided with a riveted and/or bonded damping shim. This is secured to the back face of the pad, in a position between the pad and piston, or pad and reaction face 6, depending which side of the disc the pad is located.

The damping shim may comprise an inner shim and an outer- or cover-shim. The inner shim is bonded and/or riveted in place onto the back face of the backing plate and is provided with a low friction PTFE or stainless steel face on its back face. The outer or cover shim overlays this and abuts the back face of the icier shim and comprises a stainless steel main body. This preferably comprises a rubber layer 151 at its back face for contact of the hydraulically drive piston 4 or oppositely arranged caliper housing contact area 6 used to press the pads 100 against the rotating disc 5. The cover shim is secured to the backing plate of the pad assembly by clips. The tangential spacing between the clips 153 that engage the tangential ends faces of the backing plate is large enough to ensure the cover shim can slide in a tangential direction over the surface of the damping shim.

By tangential we mean movement of the brake pad assembly in a direction that follows a point on the brake disc as the brake disc rotates about its axis.

### SUMMARY OF THE INVENTION

A feature of the present invention is to overcome certain limitations of the above form of brake assembly in particularly that may arise during operation at low braking forces or following incorrect assembly of the parts of the brake assembly.

According to a first aspect the invention provides a hydraulic brake caliper assembly comprising a support bracket, a caliper, a pair of spaced apart brake pad assemblies, each brake pad assembly comprising a backing plate and a brake pad of friction material secured to the backing plate, at least one piston which in use acts upon one of the brake pad assemblies to urge the brake pad into engagement with a surface of the brake disc, further in which the support bracket includes a pair of abutment sections associated with each brake pad assembly that are located so that during frictional engagement of the brake pad with a rotating brake disc one of the abutment sections abuts the backing plate of the brake pad to transfer reaction forces applied to the brake pads by the brake disc into the caliper, and in which at least one of the brake pad assemblies further comprises an inner shim secured to the back face of the backing plate that faces away from the brake pad, and an outer shim that overlays the inner shim and is secured to the backing plate by a plurality of retaining clips, characterized in that the retaining clips are so constructed and arranged to resiliently deflect in use to permit tangential movement of the backing plate relative to the outer shim whilst the backing plate is engaged with at least one of the resilient clips thereby to provide a degree of self centering of the outer shim relative to the backing plate within an allowable range of movement.

By tangential we mean a general approximately circumferential movement of the backing plate from side to side, and which will generally be a linear side to side movement rather than an arcuate circumferential movement about the axis of rotation of the brake disc. However, the word tangential in this application may therefore be interpreted broadly and generally to cover a side to side movement which may also follow a circumference of the brake disc, and as such will not follow a straight line through the whole of the movement and the skilled person will understand how to interpret such a term.

The resilient clips may be configured in use to allow the backing plate to move over a range of tangential positions relative to the outer shim, and in which the resilient clips are arranged such that when the brake pad is not being urged into frictional engagement with the brake disc the outer shim is actively urged by the resilient clips into a predetermined position that lies between the ends of the available range of tangential positions.

The predetermined position may be one in which any additional fixing clips provided on the outer shim at the top or bottom edge are spaced apart from any radial projections of the backing plate. This ensures that those clips will not impede sliding of the backing plate over the outer shim.

There may be a resilient clip associated with each end of the backing plate, and the clips may contact the backing plate at all times. When deformed the clips apply a generally tangential force to the backing plate.

The range of movement achievable while resiliently deflecting the clips may be at least equal to the available tangential range of positions of the backing plate between the abutment sections of the caliper.

The invention addresses problems with prior art damping shims. In a prior known arrangement which employs a sliding shim, the brake pad assembly may be located at a range of tangential positions bounded by the two rigid abutment sections. During initial braking the pad backing plate and inner shim will move tangentially to one side or the other relative to the outer shim.

For the brake pad backing plate to move tangentially, the friction between the inner shim and the outer shim must first be overcome. A certain level of braking force is needed before this occurs, the low friction coating being provided for the purpose of reducing the level of this force. The outer shim, with the rubber coating, of course grips the piston or reaction surface so it does not follow the movement of the inner shim and backing plate during this phase.

The applicant has appreciated that a problem may arise if the outer shim can be fitted onto the backing plate, or can move to a position, where there is contact between a tangentially rigid part of the outer shim and the backing plate. These parts typically include the clips on the top and bottom edges of the pad that prevent radial movement and which can strike radial edges of the backing plate. They also include the rigid clips that may be provided on the sides that limit the maximum tangential movement of the backing plate relative to the outer shim. This would prevent the pad from being able to slide relative to the outer shim towards the abutment sections at low brake pressures where the tangentially directed forces on the brake pad are low and the outer shim grips the piston. Of course, at higher pressures the outer shim will slide tangentially relative to the piston or reaction face of the caliper, dragged by the backing plate, allowing the pad to move but this may not be an acceptable behavior.

By providing resilient clips that achieve a degree of self centering of the outer shim relative to the backing plate within a range of movement, it can be assured that the backing plate will not contact a rigid part of the outer shim prior to engaging the abutment regardless of how it is initially fitted, ensuring the pad can slide to the rigid abutments at low pressures. The degree of self centering ensures there is always some room for the backing plate to move relative to the outer shim when the outer shim grips the piston.

The resilient clips may generate forces that are balanced so that the outer shim is to a degree partially or perfectly centralized relative to the backing plate within the available range of positions. The assembly may be arranged so that this is assured regardless of the relative tangential position of the backing plate and the abutments of the caliper.

The resilient clips may be sufficiently resilient as to allow, during braking, for the backing plate to move to contact an abutment section, from any start position, without requiring any movement of the outer shim relative to the piston or reaction surface of the caliper. This ensures that the friction between the outer shim and piston or contact surface does not need to be overcome for the backing plate to complete its tangential movement,

For example, the resilient clips may each provide a resistance to tangential movement of the outer shim relative to the backing plate of less than the frictional force between the outer shim and the piston, or outer shim and reaction surface of the caliper.

The resilient clips may be permanently elastically deformed by the backing plate by arranging for the spacing between the resilient clips at rest prior to inserting the backing plate to be less than the relevant radial spacing between the portion of the backing plate that engage the resilient clips after insertion.

By centralized we may mean exactly in the centre of the range of movement, or simply that the outer shim is positioned somewhere within the range of movement where it is positively spaced from an end position, so there is always some movement available.

The range of movement of the outer shim relative to the backing plate may exceed the range of tangential movement of the backing plate between the abutment means.

The range of movement of the outer shim relative to the backing plate may be equal to the available tangential movement of the backing plate between the radial abutment sections.

The outer shim may comprise a metal plate defining a planar main body and the resilient clips may each comprise protruding metal fingers that each extend out of the plane of the generally planar main body of the shim towards the brake disc, that may engage with edge portions of the backing plate. These portions of the backing plate may comprise segments of the end faces of the backing plate.

There may be one resilient clip opposing tangential movement of the cover shim in each of the two opposed tangential directions, i.e. for forward and backwards rotation of the brake disc.

Alternatively, there may be two resilient clips opposing tangential movement in each direction, i.e. a total of at least four clips.

Each of the resilient clips may comprise a root portion that is connected at one end to the main body of the outer shim and extends away from the main body of the outer shim in a direction away from the backing plate and then turns back on itself to extend back past the main body to form a contact portion that protrudes from the main body in a direction towards the backing plate. The clip may therefore be generally U-shaped. Both the root portion and the contact portion may be resiliently flexible and as such define two leaf springs.

By providing a U-shaped clip the overall length of the clip from the root to the point where it acts upon the backing plate is longer than would be possible if the clip were straight from the outer shim to the backing plate, increasing the deflection that is achievable before the elastic limit of the clip is exceeded.

The root portion may extend generally orthogonally away from the main body of the outer shim. The root may extend in a direction away from the backing plate before the clip turns back on itself to extend in a direction towards the backing plate.

The contact portion may be straight or may include one or more folds defining changes in direction. These folds may assist with the ease of assembly of the outer shim onto the backing plate. The folds may make a relatively insignificant contribution to the ability of the contact portion to deflect, the major source of deflection being resilient bending of the clip along its length.

The width of the resilient clip in the region where the root portion transitions into the contact portion may be greater than the width of the contact portion and optionally greater than the width of the root portion. The thickness of the resilient clip may be uniform and may be the same as the thickness of a main body of the cover shim. This allows the outer shim and resilient clips to be integrally formed, for example from a single sheet of material using an appropriate process such as cold forming.

The arrangement of the resilient clip defining two leaf springs ensures there is no tangentially rigid portion of the resilient clip that can block the movement of the backing plate relative to the outer shim by placing the root clear of the backing plate for all positions of the outer shim. The greater length of the clip compared with a clip that was formed as one leaf spring also allows the resistance to deflection of the clip to be lower for a given thickness of material used to form the clip.

The resilience of the resilient clips, for instance the flex of the root and/or contact portion, should be selected to provide a minimal resistance to tangential movement of the pad relative to the shim.

The outer shim may include upper and lower clips that prevent the shim from separating from the pad during fitting of the brake pads.

The inner shim may comprise a plate which may be provided with a low friction PTFE or stainless steel face. It may typically comprise a steel main body with a rubber layer on the side facing the backplate.

The inner shim may be secured to the backing plate by an adhesive and/or by rivets or other fasteners. It should preferably not be able to move radially or tangentially relative to the backing plate.

The outer shim may comprise a rigid plate, for instance a metal plate, with a low friction PTFE or a stainless steel surface that abuts the damping shim. This ensures that the outer shim can slide easily over the damping shim.

Additionally, an optional resilient layer, for instance of rubber, may be provided that is located between the rigid sheet of the outer shim and the piston or caliper housing contact area. This helps the outer shim to grip the piston, but should allow some movement of the outer shim relative to the piston under the forces of the resilient clips when the brakes are not being applied.

The outer shim may comprise a thin metal sheet, with the resilient clips being formed by deforming parts of the metal sheet out of the plane of the body of the sheet using a suitable manufacturing process.

The sheet may comprise a sheet of austenitic stainless steel or an equivalent material.

In addition to the resilient clips that control the tangential position of the outer shim relative to the backing plate, additional fixing clips may be provided that locate the outer shim at the top, at the bottom, or at the top and bottom of the backing plate.

The fixing clips may be different to the resilient clips, in that the root of each of the fixing clips may extend from the main body of the cover shim directly towards the backing plate. The fixing clips may therefore provide a more positive end stop for any up and down (radial) movement of the backing plate relative to the carrier.

The fixing clips may be spaced from the backing plate by a clearance gap so that they do not impede the movement of the outer shim relative to the backing plate in a side-to-side tangential direction.

The brake assembly may comprise a sliding caliper type disc brake in which the caliper is slidingly secured to the support bracket by an axially moveable guide system. As such it may have a piston or pistons on one side of the disc only.

The guide system of the brake assembly may comprise two or more guide pins fixed to the caliper which each extend, when the caliper is mounted to the support bracket, into a respective axially extending guide bore arranged in the support bracket.

According to a second aspect there is provided a brake pad assembly for use in a hydraulic brake assembly of the kind set forth comprising a backing plate and a brake pad fixed to the backing plate, an inner shim that is secured to the side of the backing plate that faces away from the brake pad, and an outer shim that overlays the inner shim and is secured to the backing plate by a plurality of clips, characterized in that the clips are each configured to resiliently deflect to permit the outer shim to move over a range of tangential positions relative to the backing plate by elastic deflection of the clips, and in which the resilient clips are arranged such that when the brake pad is not in a position of use in which it is being urged into frictional engagement with a brake disc the cover shim is actively urged by the resilient clips into a position that lies between the ends of the available range of tangential movement.

Other advantages of this invention will become apparent to those skilled in the art from the following detailed description of the preferred embodiments, when read in light of the accompanying drawings.

### BRIEF DESCRIPTION OF THE DRAWINGS

FIG. 1 illustrates a sliding caliper disc brake which may incorporate a brake pad assembly that falls within the scope of the present invention;

FIG. 2 shows a bracket and the related brake pads attachment section;

FIG. 3 shows a first embodiment of a brake pad assembly that falls within the scope of one aspect of the present invention in a side view;

FIG. 4 shows the brake pad assembly of FIG. 3 in a front view;

FIG. 5 shows the brake pad assembly of FIG. 3 in a perspective view;

FIG. 6 shows the cover shim of the brake pad assembly of FIG. 3 in a front view;

FIG. 7 Shows the cover shim of the first embodiment in a top view;

FIG. 8 shows the cover shim of the first embodiment in a side view;

FIG. 9 shows the cover shim of the first embodiment in a perspective view;

FIG. 10 shows the cover shim of the first embodiment prior to cold forming;

FIG. 11 shows a second embodiment of a brake pad assembly that falls within the scope of one aspect of the present invention in a side view

[symbol]

FIG. 12 shows the brake pad assembly of FIG. 11 in a front view;

FIG. 13 shows the brake pad assembly of FIG. 11 in a perspective view;

FIG. 14 shows the cover shim of the brake pad assembly of FIG. 11 in a front view;

FIG. 15 shows the cover shim of the second embodiment in a top view;

FIG. 16 shows the cover shim of the second embodiment in a side view;

FIG. 17 shows the cover shim of the second embodiment in a perspective view;

FIG. 18 Shows the cover shim of the second embodiment prior to cold forming;

FIG. 19 shows a third embodiment of a brake pad assembly that falls within the scope of one aspect of the present invention in a side view;

FIG. 20 shows the brake pad assembly of FIG. 19 in a front view;

FIG. 21 shows the brake pad assembly of FIG. 19 in a perspective view;

FIG. 22 shows the cover shim of the brake pad assembly of FIG. 19 in a front view;

FIG. 23 shows the cover shim of the third embodiment in a side view;

FIG. 24 shows the cover shim of the third embodiment in a top view;

FIG. 25 shows the cover shim of the third embodiment in a perspective view;

FIG. 26 shows the cover shim of the third embodiment prior to cold forming;

FIG. 27 shows a fourth embodiment of a brake pad assembly that falls within the scope of one aspect of the present invention in a side view;

FIG. 28 shows the brake pad assembly of FIG. 27 in a front view;

FIG. 29 shows the brake pad assembly of FIG. 27 in a perspective view;

FIG. 30 shows the cover shim of the fourth embodiment in a front view;

FIG. 31 shows the cover shim of the fourth embodiment in a side view;

FIG. 32 shows the cover shim of the fourth embodiment in a top view;

FIG. 33 shows the cover shim of the fourth embodiment in a perspective view; and

FIG. 34 shows the cover shim of the fourth embodiment prior cold forming.

### DETAILED DESCRIPTION OF THE INVENTION

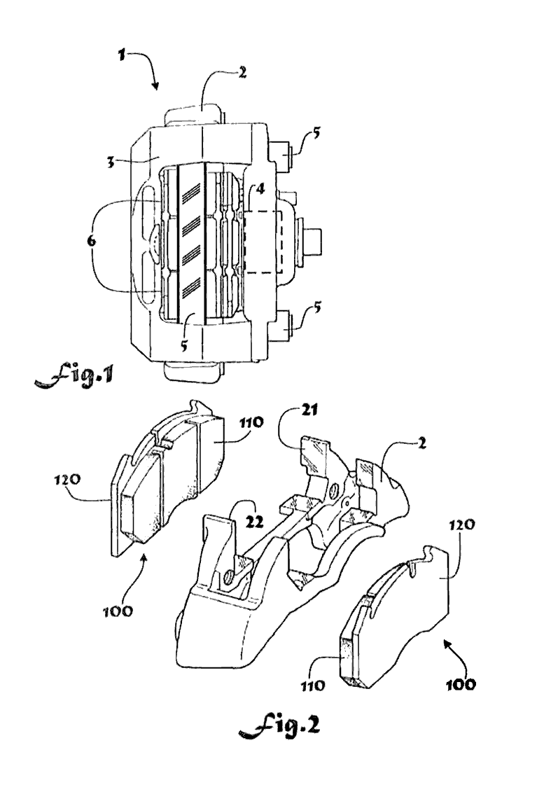

A first embodiment of a hydraulic brake caliper assembly is illustrated in FIGS. 1 to 11 of the accompanying drawings. The caliper assembly comprises a support bracket, a caliper slidingly secured to the support bracket by an axially moveable guide system. A pair of brake pad assemblies is located on opposing sides of a brake disc (not shown). Each brake pad assembly comprising a backing plate having a top face, a bottom face and two tangentially spaced edges. A brake pad of friction material is rigidly secured to the backing plate. The caliper supports at least one piston which in use acts between one of the pads and the caliper to urge the brake pad into engagement with a surface of the brake disc.

During a braking operation, the reaction force between the brake pad and the rotating disc as the brake pad is pressed onto the rotating disc will tend to pull the brake pad assembly tangentially around in the direction of rotation of the disc. This is resisted by the presence of a pair of radial abutment sections that protrude from the bracket that engage with edges of the backing plate of each brake pad assembly. The abutments are located so that one of the abutment sections abuts the backing plate of the brake pad when the disc is rotating in a clockwise direction to transfer reaction forces applied to the brake pads by the brake disc into the caliper during frictional engagement of the pad with a rotating brake disc. When the disc is rotating in the opposite direction the other abutment will engage the brake pad assembly to perform this function. Because of dimensional tolerances and the need to easily insert and remove the brake pad assembly from the caliper during installation and replacement of worn out brake pads, the tangential spacing between the abutments slightly exceeds the tangential width of the brake pad assembly so that it will shuttle to and fro between the abutments during braking depending on whether the vehicle is travelling forwards or backwards during braking.

The backing plate is provided with an inner shim having an outer layer of low friction material that is secured to the side of the backing plate that faces away from the brake pad, and an outer, or cover, shim is provided that comprises a sheet of metal that is also covered with low friction material that contacts the low friction surface of the inner shim. The outer shim is secured to the backing plate by a plurally of clips and is able to move tangentially relative to the backing plate, sliding over the inner shim. The surface of the cover shim that faces the piston or caliper reaction surface is provided with a rubber coating so that it grips the piston or reaction surface. The rubber helps reduce unwanted brake squeal.

The clips 152 are designed in use to resiliently deflect to permit the outer shim and backing plate to move relative to each other into a range of different tangential positions. The resilient clips are arranged such that when the brake pad is not being urged into frictional engagement with the brake disc the outer shim is actively urged by the resilient clips into a position that lies between the extreme end positions of the range.

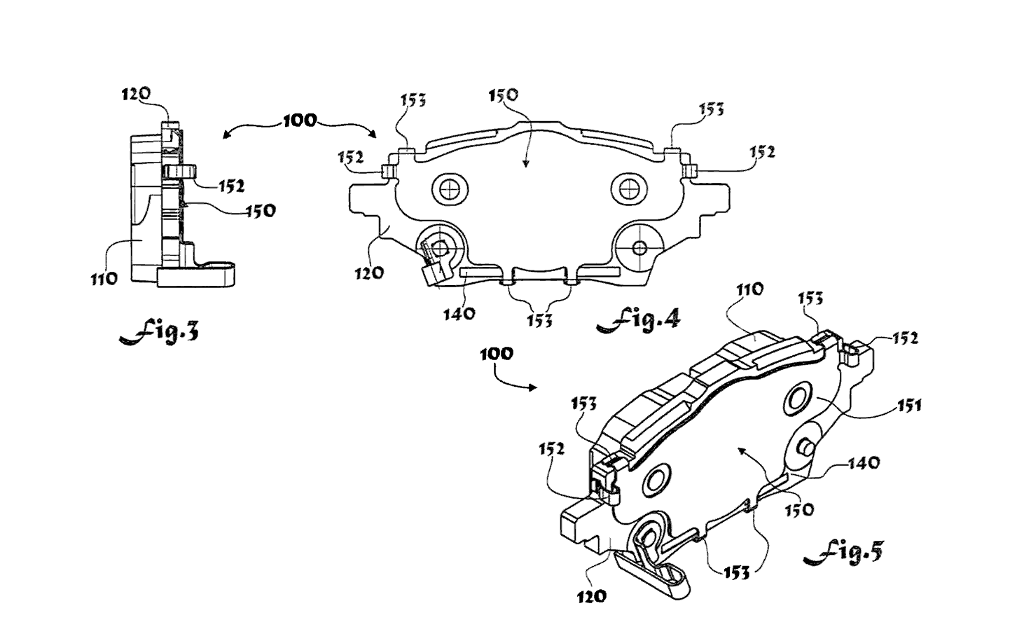

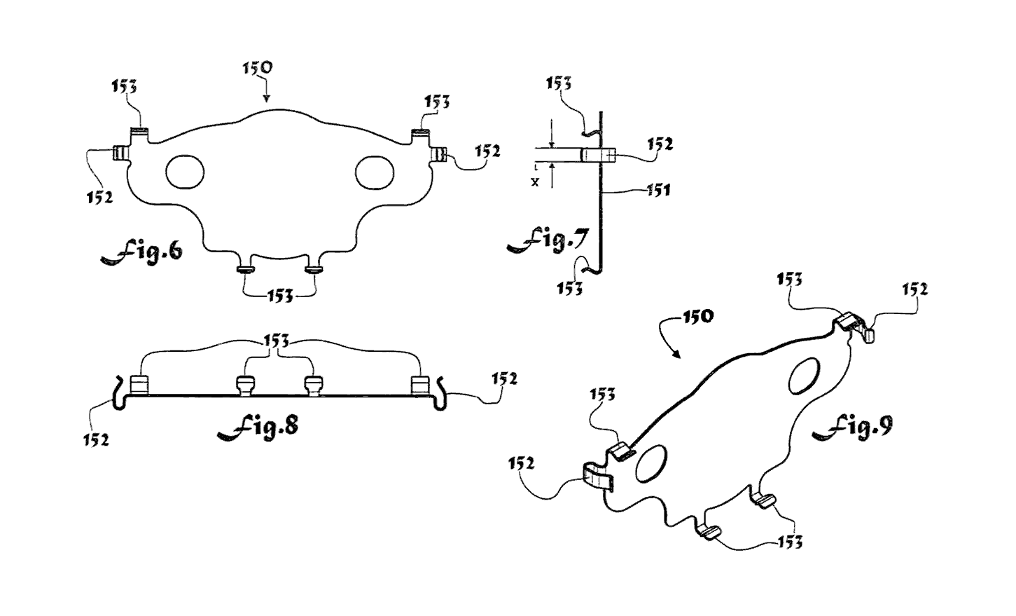

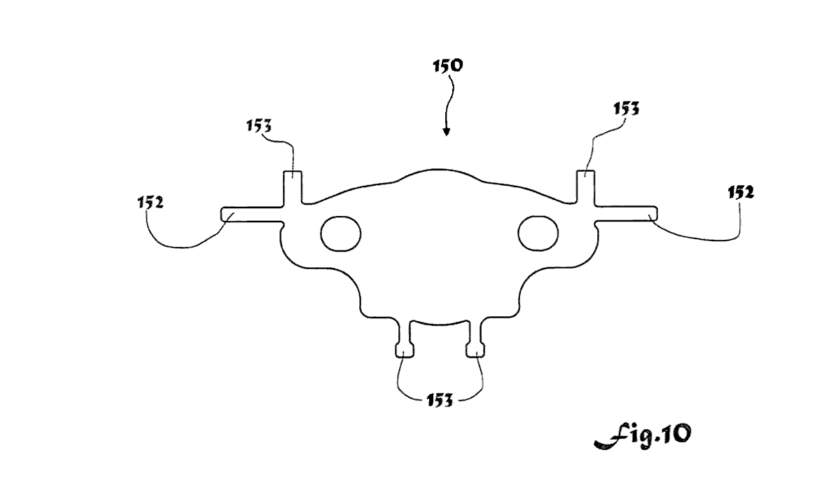

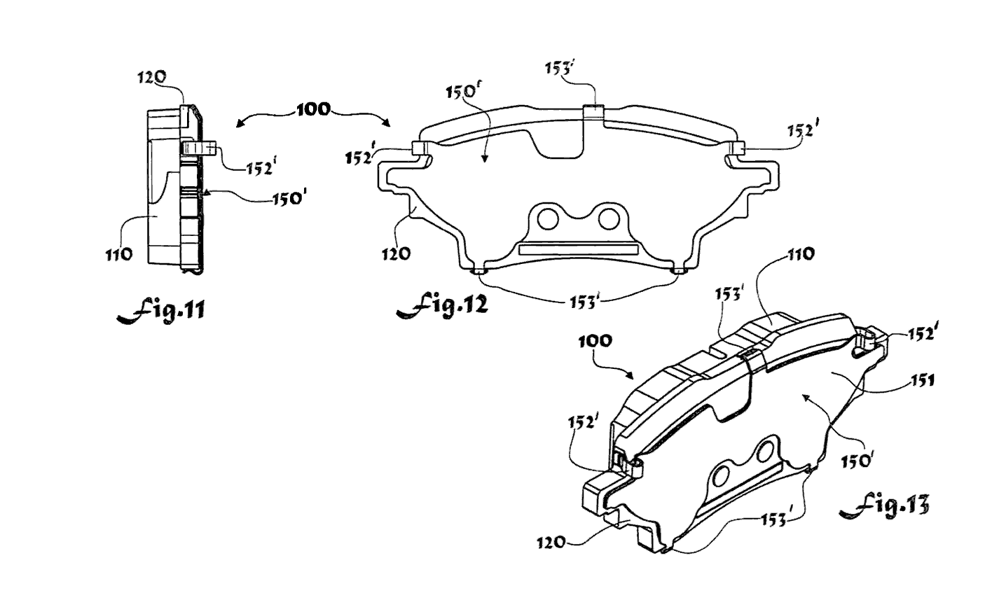

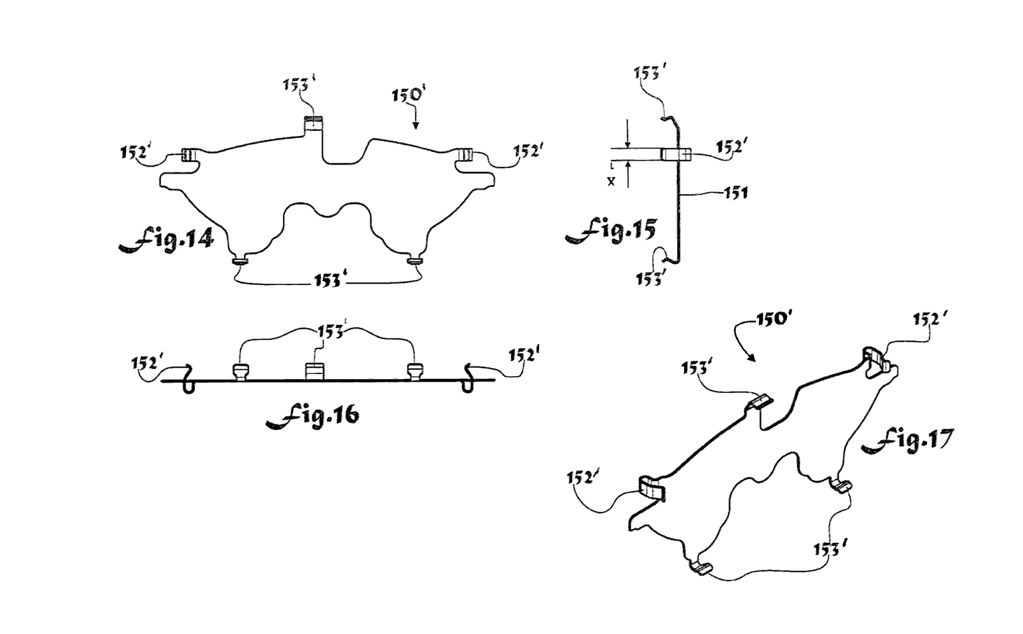

As can be seen in FIG. 10, the outer shim comprises a planar main body with bent tangs or fingers protruding from the edges to define the material for two resilient clips 152 and four fixing clips 153, two arranged at the top and two at the bottom end. The sheet is folded to form the two resilient clips and the fixing clips as shown in FIGS. 6 to 9. The fixing of the outer shim to the backing plate is shown in FIGS. 3 to 5 and FIGS. 11-13. The clips 152 and 153 hold the outer shim on the back plate 120 surrounding its side edges as illustrated in FIG. 5 allowing the above described tangential sliding of the brake pad backing plate onto the abutment sections at low brake pressures wherein the resilient clips elastically deflects.

The outer shim 150 therefore has a side to side self centering spring feature provided by the resilient clips 152 acting on the back plate 120 to centralize the outer shim 150 relative to the backing plate and maintain a gap between any tangentially rigid part of the shim—including any rigid part of the clip. The higher friction interface, rubber covered side 151 of outer shim 150 to hydraulically and/or electromechanically driven piston 4 or caliper housing contact means 6 maintains position of outer shim 150 relative to them when the brake is applied and the pad 100 slides on the lower friction shim interface in sliding contact with the damping shim to the bracket abutment means 21, 22 deflecting the resilient clips 152.

When the brake is released the resilient clips 152 returns the outer shim 150 to a centralized position thus maintaining gap between fixing clip 153 and back plate profile 120.

Resilient clip 152 geometry is designed such that spring force when deflected is only sufficient to centralize and offers minimal resistance to pad movement.

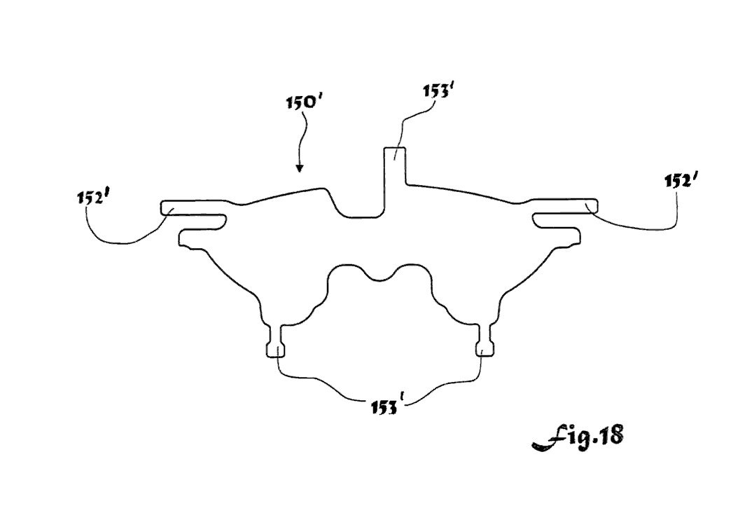

A second embodiment of a brake pad assembly that can be used with a brake caliper of the kind shown in FIG. 1 is illustrated in FIGS. 11 to 18 of the accompanying drawings. The brake pad assembly differs from the first embodiment in the shape of the outer shim 150′. In this embodiment the outer shim 150′ comprises again a planar main body made of sheet metal showing at each side of the shim two resilient clips 152′ and three fixing clips 153′, one arranged at the top and two at the bottom end which hold the outer shim on the back plate 120 surrounding its side edges as illustrated in FIG. 13 allowing the above described tangential sliding at low brake pressures wherein the resilient clips 152′ deflects.

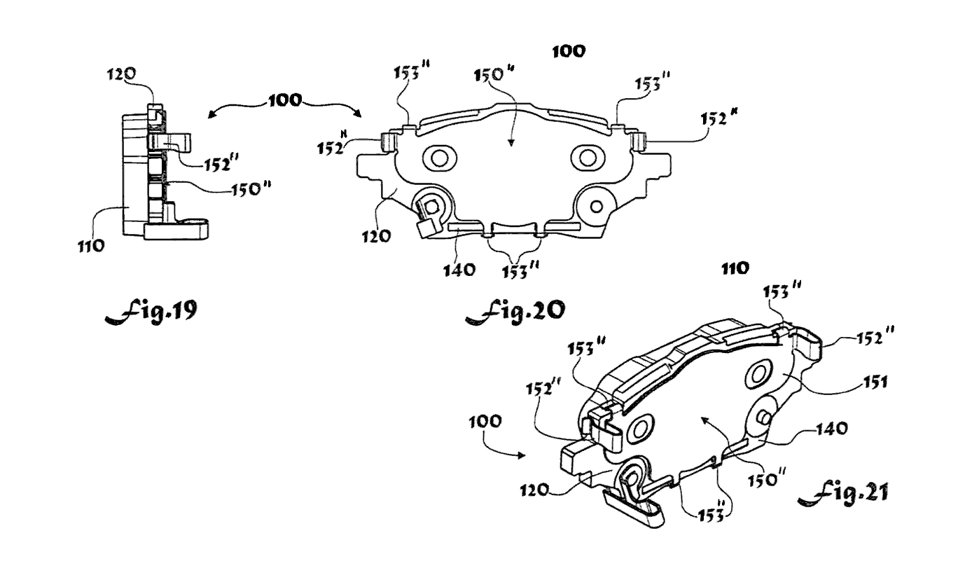

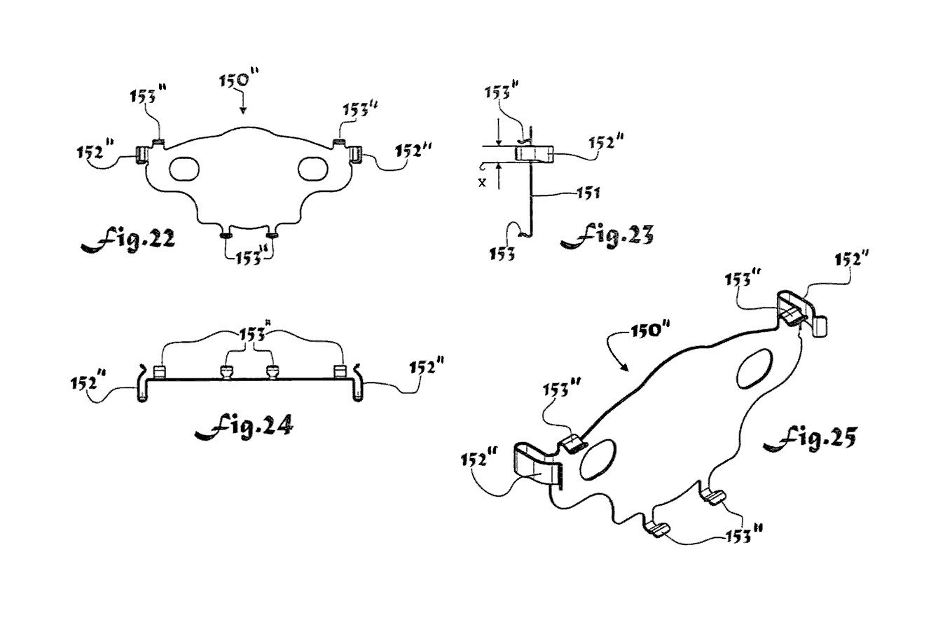

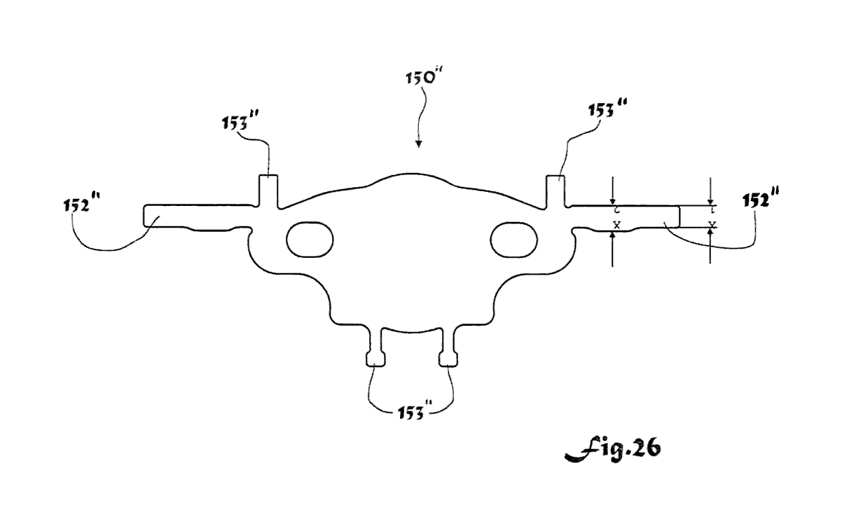

A modified version of the brake pad assembly of the first embodiment is illustrated in FIGS. 19 to 26 of the accompanying drawings. This comprises again a body made of sheet metal showing at each side of the shim two more robust resilient clips 152″ where at least one section X2 is of a bigger dimension than before (X1/FIG. 7) and four fixing clips 153″, two arranged at the top and two at the bottom end which hold the cover shim on the back plate 120 surrounding its side edges as illustrated in FIG. 21 allowing the above described sliding at low brake pressures wherein the resilient clips 152″ elastically deflects. In this modified version, the 152 clips are longer to increase deflection range and keep stress within elastic limit, but this also reduces clip force on backplate when compared with the preceding embodiment. To restore the force back to the target this embodiment includes an increased dimension X2.

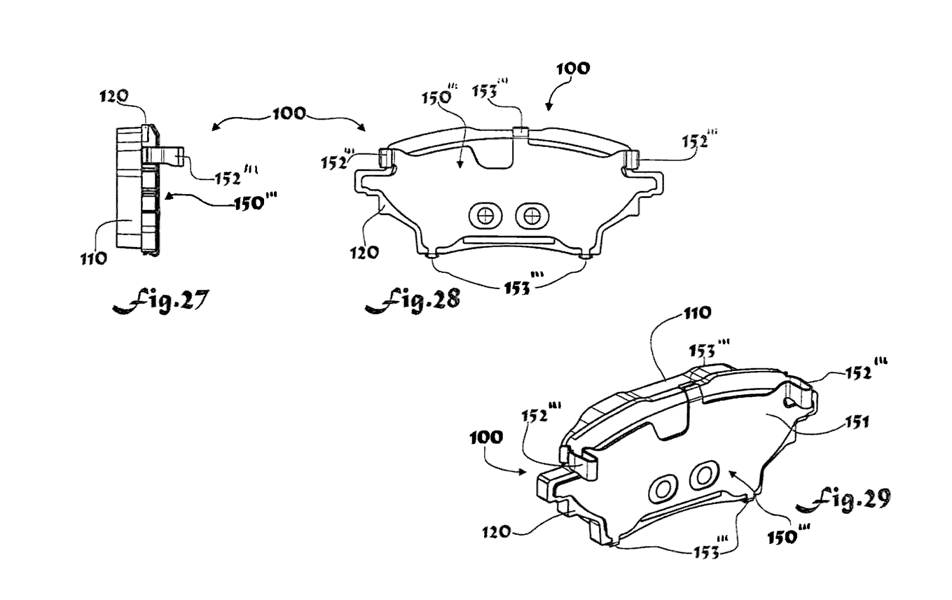

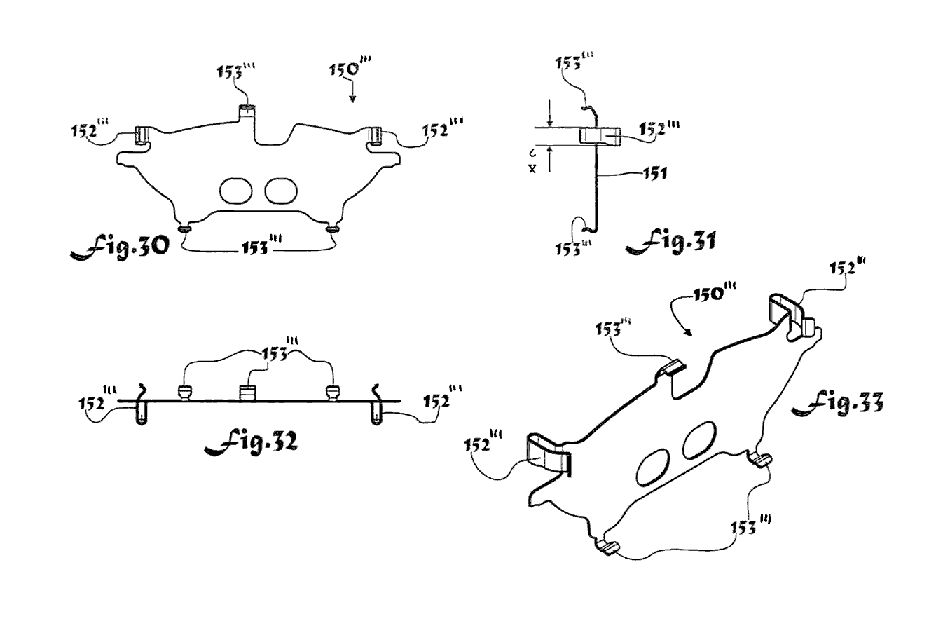

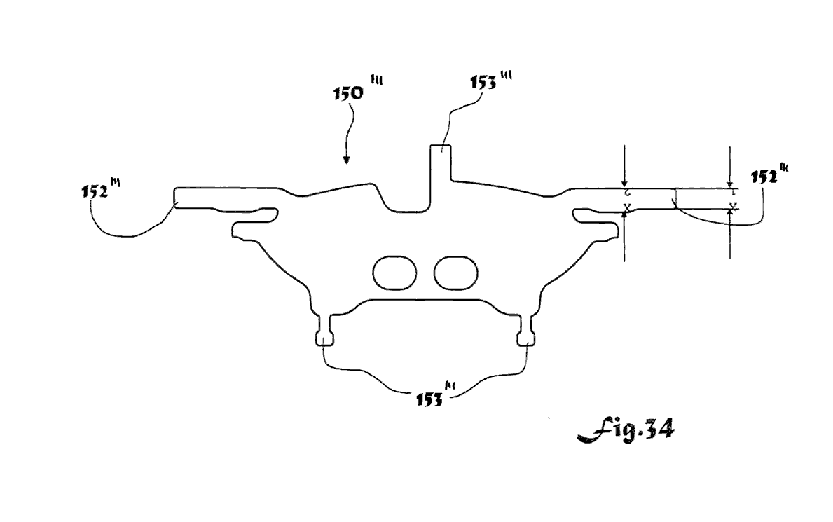

A modified version of the brake pad assembly of the second embodiment is illustrated in FIGS. 27 to 34 of the accompanying drawings. This comprises again a main body made of sheet metal showing at each side of the shim two more robust resilient clips 152′″ where at least one section X2 is of a bigger dimension than before (X1/FIG. 15) and three fixing clips 153″, one arranged at the top and two at the bottom end which hold the outer shim on the back plate 120 surrounding its side edges as illustrated in FIG. 13 allowing the above described sliding at low brake pressures wherein the resilient clips 152′″ deflects.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A hydraulic brake caliper assembly comprising: a support bracket, a caliper, a pair of spaced apart brake pad assemblies, each brake pad assembly comprising a backing plate and a brake pad of friction material secured to the backing plate, at least one piston which in use acts upon one of the brake pad assemblies to urge the brake pad into engagement with a surface of a brake disc, further in which the support bracket includes a pair of abutment sections associated with each brake pad assembly that are located so that during frictional engagement of the brake pad with a rotating brake disc one of the abutment sections abuts the backing plate of the brake pad to transfer reaction forces applied to the brake pads by the brake disc into the caliper, and in which at least one of the brake pad assemblies further comprises an inner shim secured to a back face of the backing plate that faces away from the brake pad, and an outer shim that overlays the inner shim and is secured to the backing plate by a plurality of resilient clips, wherein the resilient clips are so constructed and arranged to resiliently deflect in use to permit tangential movement of the backing plate relative to the outer shim whilst the backing plate is engaged with at least one of the resilient clips so as to provide a degree of self centering of the outer shim relative to the backing plate within an allowable range of movement.

2. The hydraulic brake caliper assembly according to claim 1 in which the resilient clips are configured in use to allow the backing plate to move over a range of tangential positions relative to the outer shim, and in which the resilient clips are arranged such that when the brake pad is not being urged into frictional engagement with the brake disc the outer shim is actively urged by the resilient clips into a predetermined position that lies between the ends of an available range of tangential positions.

3. The hydraulic brake caliper assembly according to claim 2 in which the predetermined position may be one in which any additional fixing clips provided on the outer shim at a top or bottom edge thereof are spaced apart from any radial projections of the backing plate.

4. The hydraulic brake caliper assembly according to claim 1 in which at least one resilient clip is provided at each end of the backing plate, and the at least one resilient clip provided at each end of the backing plate contacts the backing plate at all times.

5. The hydraulic brake caliper assembly according to claim 2 in which the range of movement achievable while resiliently deflecting the resilient clips is at least equal to the available tangential range of positions of the backing plate between the abutment sections of the caliper.

6. The hydraulic brake caliper assembly according to claim 1 in which the resilient clips generate forces that are balanced so that the outer shim is to a degree partially or perfectly centralized relative to the backing plate within the available range of position regardless of the relative tangential position of the backing plate and the abutments of the caliper.

7. The hydraulic brake caliper assembly according to claim 1 in which the resilient clips are sufficiently resilient as to allow, during braking, for the backing plate to move to contact an abutment section, from any start position, without requiring any movement of the outer shim relative to the piston or reaction surface of the caliper.

8. The hydraulic brake caliper assembly according to claim 1 in which the resilient clips each provide a resistance to tangential movement of the outer shim relative to the backing plate of less than a frictional force between the outer shim and the piston, or outer shim and a reaction surface of the caliper.

9. The hydraulic brake caliper assembly according to claim 1 in which the outer shim comprises a metal plate defining a planar main body and the resilient clips each comprise protruding metal fingers that each extend out of the plane of the generally planar main body of the shim towards the brake disc to engage with edge portions of the backing plate.

10. The hydraulic brake caliper assembly according to claim 1 in which there is one resilient clip opposing tangential movement of the cover shim in each of the two opposed tangential directions.

11. The hydraulic brake caliper assembly according to claim 1 in which there are two resilient clips opposing tangential movement in a forward direction and two resilient clips opposing tangential movement in a backwards direction.

12. The hydraulic brake caliper assembly according to claim 9 in which each of the resilient clips comprise a root portion that is connected at one end to the main body of the outer shim and extends away from the main body of the outer shim in a direction away from the backing plate and then turns back on itself to extend back past the main body to form a contact portion that protrudes from the main body in a direction towards the backing plate.

13. The hydraulic brake caliper assembly according to claim 12 in which the root portion extends generally orthogonally away from the main body of the outer shim in a direction away from the backing plate before the resilient clip turns back on itself to extend in a direction towards the backing plate to define two leaf springs.

14. The hydraulic brake caliper assembly according to claim 12 in which the contact portion is straight or or is configured to include one or more folds defining changes in direction where the folds make a relatively insignificant contribution to the ability of the contact portion to deflect, the major source of deflection being resilient bending of the resilient clip along its length.

15. The hydraulic brake caliper assembly according to claim 12 in which a width of the resilient clip in the region where the root portion transitions into the contact portion is greater than a width of the contact portion.

16. The hydraulic brake caliper assembly according to claim 1 in which the outer shim includes upper and lower clips that prevent the slum from separating from the brake pad during fitting of the brake pads.

17. The hydraulic brake caliper assembly according to claim 1 in which the inner shim comprises a plate that is provided with a low friction PTFE or stainless steel face.

18. The hydraulic brake caliper assembly according to claim 1 in which the inner shim is secured to the backing plate by an adhesive and/or by rivets or other fasteners.

19. The hydraulic brake caliper assembly according to claim 1 in which the outer shim comprises a rigid plate with a low friction PTFE or a stainless steel surface that abuts the shim.

20. The hydraulic brake caliper assembly according to claim 19 in which a resilient layer is provided that is located between the rigid plate of the outer shim and the piston or caliper housing contact area to help the outer shim to grip the piston yet allow some movement of the outer shim relative to the piston under the forces of the resilient clips when the brakes are not being applied.

21. The hydraulic brake caliper assembly according to claim 1 in which the outer shim comprises a thin metal sheet, with the resilient clips being formed by parts of the metal sheet deformed out of the plane of a body of the metal sheet.

22. The hydraulic brake caliper assembly according to claim 21 in which the metal sheet comprises a sheet of austenitic stainless steel or an equivalent material.

23. The hydraulic brake caliper assembly according to claim 1 further includes additional fixing clips that locate the outer shim at one or more of a top and a bottom of the backing plate.

24. The hydraulic brake caliper assembly according to claim 23 in which a root of each of the fixing clips extends from the main body of the outer shim directly towards the backing plate.

25. The hydraulic brake caliper assembly according to claim 1 in which the brake assembly comprises a sliding caliper type disc brake in which the caliper is slidingly secured to the support bracket by an axially moveable guide system.

26. The hydraulic brake caliper assembly according to claim 25 in which the guide system of the brake assembly comprises two or more guide pins fixed to the caliper which each extend, when the caliper is mounted to the support bracket, into a respective axially extending guide bore arranged in the support bracket.

27. A brake pad assembly for use in a hydraulic brake assembly comprising a backing plate and a brake pad fixed to the backing plate, an inner shim that is secured to a side of the backing plate that faces away from the brake pad, and an outer shim that overlays the inner shim and is secured to the backing plate by a plurality of clips, wherein the clips are each configured to resiliently deflect to permit the outer shim to move over a range of tangential positions relative to the backing plate by elastic deflection of the clips, and in which the resilient clips are arranged such that when the brake pad is not in a position of use in which it is being urged into frictional engagement with a brake disc the outer shim is actively urged by the resilient clips into a position that lies between the ends of the available range of tangential movement.
